(19) United States
(12) Patent Application Publication
(10) Pub. No.: US 2010/0196173 A1
(43) Pub. Date: Aug. 5, 2010

(54) LINEAR COMPRESSOR

(75) Inventor: Bernd Gromoll, Baiersdorf (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/668,434

(22) PCT Filed: Jul. 3, 2008
(86) PCT No.: PCT/EP08/58621

§ 371 Date: Jan. 11, 2010

(30) Foreign Application Priority Data
Jul. 24, 2007 (DE) 10 2007 034 296.0

(51) Int. Cl. F04B 35/04; F16J 9/00

(52) U.S. Cl. 417/410.1; 92/249

(57) ABSTRACT

A linear compressor having an electromagnet; an oscillating body that moves back and forth in the alternating field of the electromagnet; a piston that is connected to the oscillating body and that reciprocates in a cylinder and delineates a pump chamber; and an elastically deformable plate that forms at least one of the end faces of the pump chamber.

The present invention relates to a linear compressor, in particular for compressing refrigerant in a refrigeration appliance. Such a linear compressor conventionally includes an electromagnet for generating a magnetic alternating field, an oscillating body, which moves back and forth in the field of the electromagnet, and a piston connected to the oscillating body that reciprocates in a cylinder and delineates a pump chamber.

In the case of a compressor with a piston powered by the rotation of a crankshaft, the stroke of the piston movement is determined by the path diameter of a point, at which a piston rod engages with the crankshaft. The dead volume of the compressor can thus be made extremely small, without the fear of the piston striking an opposite end face of the pump chamber. A minimization of the dead volume is important in order to achieve a high degree of efficiency of the compressor.

A linear compressor lacks such a design-specific delineation of the piston stroke. The piston stroke can vary depending on the operating conditions of the compressor. To operate a linear compressor with a minimal dead volume and in this way prevent the piston from striking the opposite end face of the pump chamber, which would over time result in the compressor becoming damaged, the piston stroke must be continuously monitored and the frequency and/or amplitude of the alternating field must be continuously adjusted so that the piston movement maintains a safe distance from the opposite end face of the pump chamber at all times.

To be able to select a minimal safe distance between the piston on its upper dead point and the opposite end face of the pump chamber and consequently to reliably prevent an impact, a very precise and correspondingly complex and cost-effective controller is needed.

The object of the present invention is to create a linear compressor, which can achieve a high degree of efficiency without having to place high demands on the accuracy of a controller of the piston movement.

The object is achieved by at least one of the end faces of the pump chamber being formed by an elastically deformable plate in the case of a linear compressor comprising at least one electromagnet, at least one oscillating body moving back and forth in an alternating field of the electromagnet, and at least one piston connected to the oscillating body that reciprocates in a cylinder and delineates a pump chamber. As such a plate cushions a possible impact of the piston against the opposite end face, the sensitivity of the compressor to an impact of the piston is reduced and a soft impact can be accepted without negatively affecting the service life of the compressor. With the inventive linear compressor, a minimal safe distance can thus be selected without risk between the piston and the opposite end face, as a result of which the dead volume is minimized and high degree of efficiency is achieved.

The elastic plate can line a fixed end face of the pump chamber; it can however also be a cover of the piston itself. Depending on the thickness and/or elasticity properties of the plate, it may be advantageous if the elastic plate covers a fixed plate of the piston so that it is supported by this against the pressure prevailing in the pump chamber; the piston may however also be hollow and the elastic plate may span a cavity of the piston. The latter is advantageous in that it enables the weight of the piston to be reduced.

In both cases, a valve can be expediently integrated into the elastic plate.

According to a preferred embodiment, the pump chamber is delineated on both end faces by the piston; in such a case, both pistons are preferably provided with elastically deformable plates.

Further features and advantages of the invention result from the subsequent description of exemplary embodiments with reference to the appended Figures, in which:

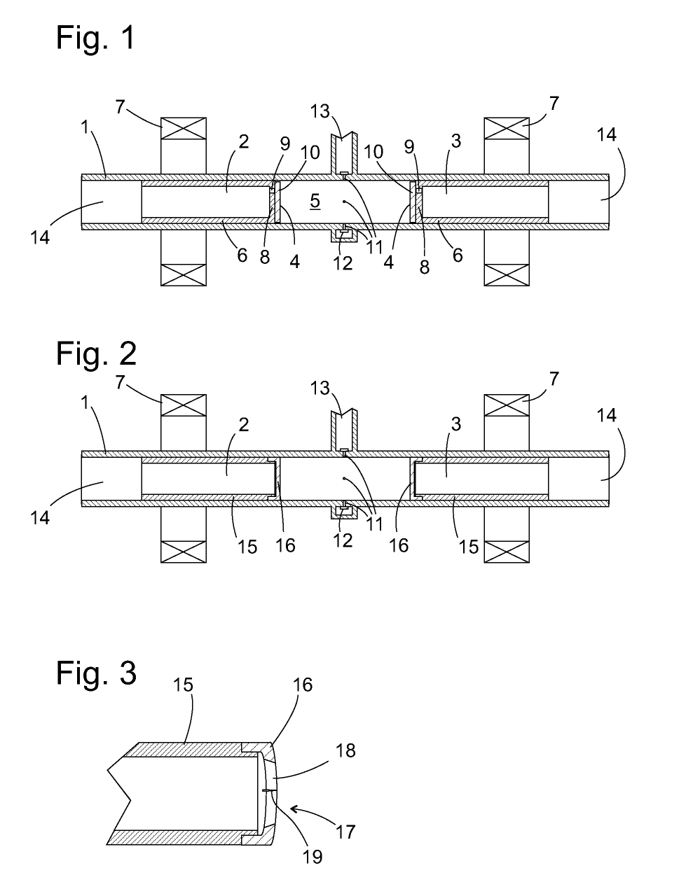

FIG. 1 shows a schematic section through a linear compressor according to a first embodiment of the invention;

FIG. 2 shows a section similar to FIG. 1 through a linear compressor according to a second embodiment of the invention; and

FIG. 3 shows an enlarged section through a piston of the linear compressor.

The linear compressor shown in FIG. 1 includes a cylindrical tube 1, in which two pistons 2, 3 are received in a reciprocating fashion. The tube 1 and the end faces 4 of the piston 2, 3 which face one another delineate a pump chamber 5.

The pistons 2, 3 are embodied in the manner of a cup in each instance, with the bases of the cups forming end faces 4 which face one another. The walls 6 of the cups are formed at least partially by permanent magnets, which interact with a magnetic alternating field generated by coils 7, in order to power a reciprocating movement of the pistons 2, 3. The coils 7 are shown here by way of example as annular coils extending around the tube 1, various other coil arrangements are known within the field of linear compressors and are likewise suitable within the scope of the present invention. Other coil arrangements are also possible, which can then also power the pistons 2, 3, if these only consist of a ferromagnetic, but not permanently magnetized material.

The end faces 4 of the pistons 2, 3 each include a metallic plate 8 fixedly connected to the walls 6, through which a bore 9 extends, and an elastic plate 10 which is fastened in a punctiform manner to the metallic plate 8, said elastic plate consisting of a rubber material, a foam or suchlike.

Several radial bores 11 extend through the tube 1 along a center plane. A rubber band 12 rests against the outsides of the bores 11.

If the pistons 2, 3 move together when powered by the magnetic field of the coils 7, refrigerant contained in the pump chamber 5 is compressed until it pushes the rubber band 12 to one side and escapes through the bores 11 to an outlet 13 of the compressor. The pistons 2, 3 cushioned by the elastic plates 10 may touch one another gently on the center plane without causing any damage. The dead volume of the compressor is then practically zero and the degree of efficiency is optimal.

With a subsequent separating movement of the pistons 2, 3, the pressure in the pump chamber 5 is lower than that at the ends of the cylindrical tube 1 forming at the inlets 14 in each instance, so that the plates 8 are pressed to one side and refrigerant flows into the pump chamber 5 through the bores 9. With the next change in direction of the pistons 2, 3, this is in turn expelled through the bores 11.

The embodiment in FIG. 2 differs from that in FIG. 1 in that the pistons 2, 3 are assembled from metallic, at least partially magnetic tube sections 15, which are sealed at their ends facing one another by an elastic plate 16 in each instance. Since the plates 16 are only supported against the pressure prevailing in the pump chamber 5 by the tubular sections 15 at their edges, they can yield in the middle. If the opposing surfaces of the plates 16 adopt a concave form here, compressed refrigerant remains caught therebetween if they impact and assists with the cushioning effect of the plates 16.

Alternatively, the plates 16 can have opposing convex sides in a relaxed state, as can be seen in the enlarged representation of a piston in FIG. 3. If this curvature is measured such that the plates 16, during a compression phase, adopt a planar form when pressurized by the refrigerant in the pump chamber 5, the dead volume here can also be practically zero when the plates 16 impact.

The curved form of the plates 16 also enables the realization of inlet valves 17 for the pump chamber 5 in the form of simple slots in the plates 16. These can be arranged crosswise for instance, with the section in FIG. 3 running in the longitudinal direction of a slot 18 and at right angles to a slot 19. If the plate 16 adopts a planar form during a compressor phase, the walls of the slots 18, 19 are pressed against one another so that the valve 17 closes. In a suction phase, in which pressure in the pump chamber 5 is lower than at the inlets 14, the curvature of the plate 16 intensifies and the slots 18, 19 open.

1-6. (canceled)

7. A linear compressor, comprising:
an electromagnet having an alternating field;
an oscillating body moving back and forth in the alternating field of the electromagnet;
a cylinder;
a pump chamber having end faces;
a piston connected to the oscillating body, the piston structured to reciprocate in the cylinder and to delineate the pump chamber; and
an elastically deformable plate that forms at least one of the end faces of the pump chamber.

8. The linear compressor of claim 7, wherein the piston has a cover, and wherein the elastically deformable plate forms the cover of the piston.

9. The linear compressor of claim 8, wherein the piston has a fixed plate, and wherein the elastically deformable plate forms the fixed plate of the piston.

10. The linear compressor of claim 8, wherein the piston is hollow and wherein the elastically deformable plate spans a cavity of the piston.

11. The linear compressor of claim 7, further comprising a valve that is integrated into the elastically deformable plate.

12. The linear compressor of claim 7, wherein the piston delineates the pump chamber on both of the end faces of the pump chamber.
